(19) United States
(12) Patent Application Publication
(10) Pub. No.: US 2013/0196663 A1
(43) Pub. Date: Aug. 1, 2013

(54) SYSTEM SELECTION IN MULTI-RAT USER EQUIPMENT

(71) Applicants: Andrzej Yurkevich, San Diego, CA (US); Jan C. Ault, Santee, CA (US); Shyamal Ramachandran, San Diego, CA (US)

(72) Inventors: Andrzej Yurkevich, San Diego, CA (US); Jan C. Ault, Santee, CA (US); Shyamal Ramachandran, San Diego, CA (US)

(73) Assignee: QUALCOMM Incorporated, San Diego, CA (US)

(21) Appl. No.: 13/477,949

(22) Filed: May 22, 2012

Related U.S. Application Data
(60) Provisional application No. 61/591,609, filed on Jan. 27, 2012.

(51) Int. Cl. H04W 60/00; H04W 88/06

(52) U.S. Cl. 455/435.3; 455/552.1

(57) ABSTRACT

In certain wireless communication systems, requests for connecting to a radio access technology (RAT) may be ambiguous depending on the communication configuration. For example, in certain RAT priority lists an ambiguity may exist when determining whether a UE should prioritize connection to a TD-SCDMA or WCDMA network. To remove this ambiguity, an indicator may be set in the memory of the UE to indicate network priority in the event of ambiguity. Network prioritization may be based at least in part on the indicator.

### CROSS-REFERENCE TO RELATED APPLICATION

This application claims priority to U.S. Provisional Patent Application No. 61/591,609, entitled, SYSTEM SELECTION IN MULTI-RAT USER EQUIPMENT, filed on Jan. 27, 2012, in the names of YURKEVICH, et al., the disclosure of which is expressly incorporated by reference herein in its entirety.

### BACKGROUND

1. Field

Aspects of the present disclosure relate generally to wireless communication systems, and more particularly, to an improved method of system selection in wireless communication networks where access technology identifiers may be shared between radio access technologies (RATs) available to a user equipment.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining whether a user equipment (UE) is in a coverage area of a first radio access technology (RAT). The method may also include determining whether the UE was last registered with the first RAT. The method may also include setting an indicator in non-volatile memory of the UE, when either the UE is determined to be in the coverage area of the first RAT or the UE was last registered with the first RAT. The method may also include

receiving a request for service ambiguously requesting the first RAT and a second RAT. The method may further include prioritizing between the first RAT and the second RAT for scanning based at least in part on the indicator.

According to another aspect of the present disclosure, an apparatus for wireless communication includes means for determining whether a user equipment (UE) is in a coverage area of a first radio access technology (RAT). The apparatus may also include means for determining whether the UE was last registered with the first RAT. The apparatus may also include means for setting an indicator in non-volatile memory of the UE, when either the UE is determined to be in the coverage area of the first RAT or the UE was last registered with the first RAT. The apparatus may further include means for receiving a request for service ambiguously requesting the first RAT and a second RAT. The apparatus may also include means for prioritizing between the first RAT and the second RAT for scanning based at least in part on the indicator.

According to one aspect of the present disclosure, a computer program product for wireless communication in a wireless network includes a computer readable medium having non-transitory program code recorded thereon. The program code includes program code to determine whether a user equipment (UE) is in a coverage area of a first radio access technology (RAT). The program code also includes program code to determine whether the UE was last registered with the first RAT. The program code also includes program code to set an indicator in non-volatile memory of the UE, when either the UE is determined to be in the coverage area of the first RAT or the UE was last registered with the first RAT. The program code also includes program code to receive a request for service ambiguously requesting the first RAT and a second RAT. The program code also includes program code to prioritize between the first RAT and the second RAT for scanning based at least in part on the indicator.

According to one aspect of the present disclosure, an apparatus for wireless communication includes a memory and one or more processors coupled to the memory. The processor(s) is configured to determine whether a user equipment (UE) is in a coverage area of a first radio access technology (RAT). The processor(s) is further configured to determine whether the UE was last registered with the first RAT. The processor(s) is further configured to set an indicator in non-volatile memory of the UE, when either the UE is determined to be in the coverage area of the first RAT or the UE was last registered with the first RAT. The processor(s) is further configured to receive a request for service ambiguously requesting the first RAT and a second RAT. The processor(s) is further configured to prioritize between the first RAT and the second RAT for scanning based at least in part on the indicator.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a call flow diagram illustrating an exemplary attempted UE connection setup.

FIG. 5 is a call flow diagram illustrating an exemplary attempted UE connection setup.

FIG. 6 is a flow diagram illustrating RAT preference determination according to one aspect of the present disclosure.

FIG. 7 is a flow diagram illustrating RAT preference determination according to one aspect of the present disclosure.

FIG. 8 illustrates exemplary UE memory allocation for RAT preference determination.

FIG. 9 is a block diagram illustrating RAT preference determination according to one aspect of the present disclosure.

FIG. 10 is a diagram illustrating an example of a hardware implementation for an apparatus employing RAT preference determination according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

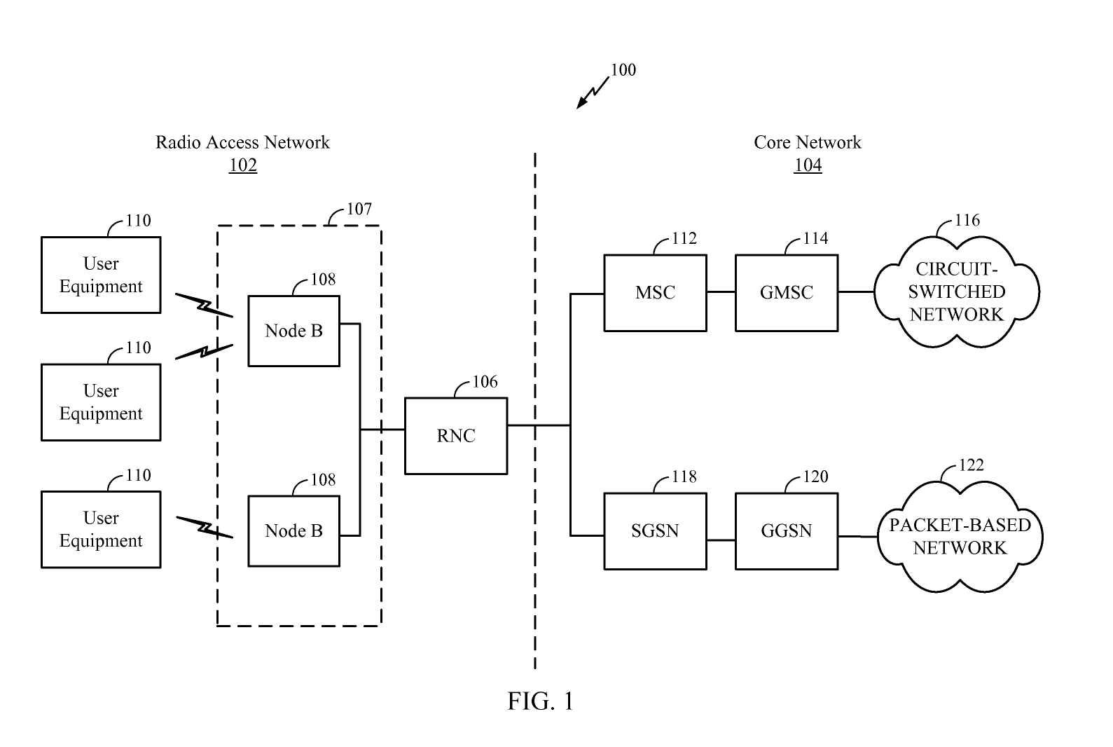

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

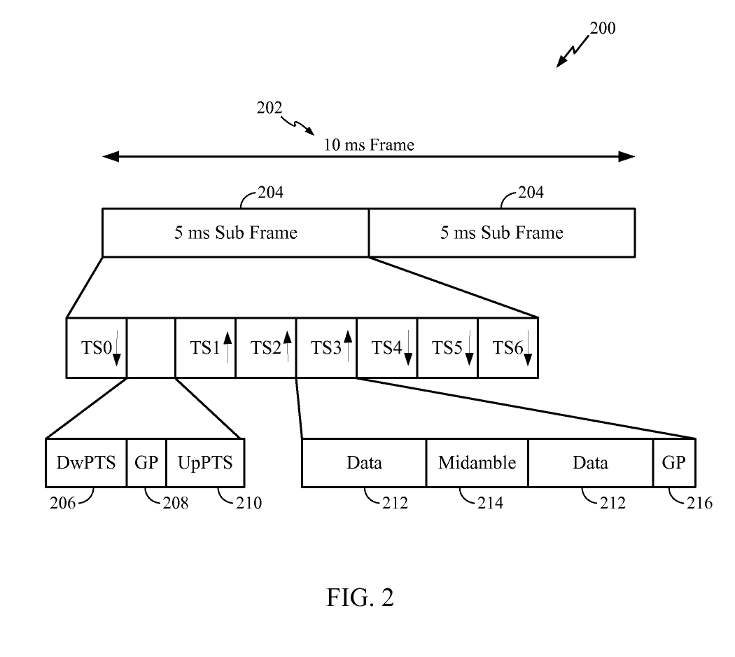

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. In the example illustrated, TS1-TS3 are allocated for uplink and TS4-TS6 are allocated for downlink. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference. The chip rate in TD-SCDMA is 1.28 Mcps.

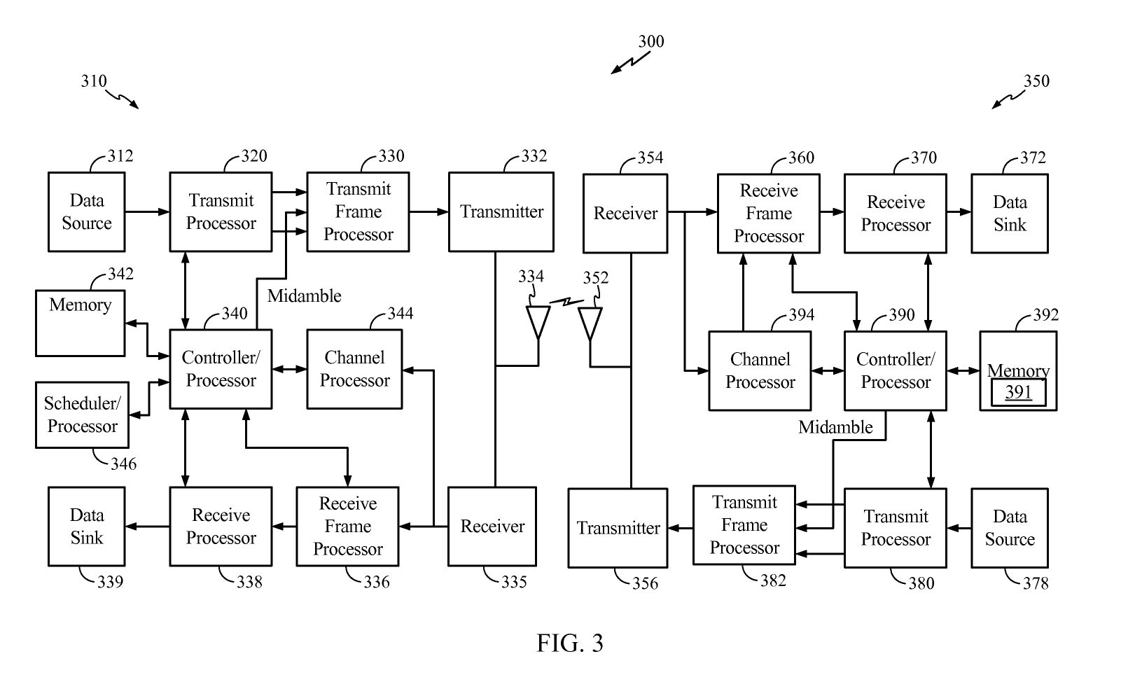

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a RAT identification module 391 which, when executed by the controller/processor 390, configures the UE 350 for dual mode operation for signal measurement scheduling. A scheduler/processor 346 at the node B 310 may be used to allocate resources to the UEs and schedule downlink and/or uplink transmissions for the UEs.

Certain mobile equipment may be configured to allow for operation on multiple wireless communication networks. For example, a UE may be capable of operating either on a TD-SCDMA/GSM network or on a WCDMA (Wideband Code Division Multiple Access) network. Certain situations may direct the UE to communicate on one particular available network. For example, a UE may operate in a geographic region (e.g., China) that supports TD-SCDMA. Accordingly, when the UE powers up in this geographic region it may prioritize scanning for an operator that supports TD-SCDMA networks because that is the network that the UE is likely to find. However, when the UE is in a different geographic region (e.g., Europe) that supports WCDMA/UMTS it may be undesirable to prioritize scanning for TD-SCDMA networks because of delay to the network selection process.

A RAT Priority List of a UE lists the priority of RATs to be acquired by the UE, when those RATs are available. The priority of RATs to be acquired is passed as one of the parameters in a Service Request message. If both RATs of a multi-RAT UE are included in the RAT Priority List, both RATs are expected to be queried for service in the single Service Request. Such a service request may be deemed ambiguous as described herein because of the ambiguity in determining the desired RAT. The position of a RAT on the RAT Priority List indicates its acquisition order priority. For example, if TD-SCDMA is listed higher than WCDMA, then TD-SCDMA should be acquired before WCDMA. Typically, to improve UE performance, the RAT on which service was last received is selected as the first one to be acquired. In certain scenarios, however, due to present Non-Access Stratum (NAS) implementation, the UE may suffer poor acquisition performance due to difficulty distinguishing between whether a most recently registered RAT is TD-SCDMA or WCDMA.

Each UE includes a USIM (Universal Subscriber Identity Module) card identifying compatible wireless networks for the UE. The USIM card stores the PLMN (public land mobile network) identification of the RAT on which the UE has acquired wireless service. The PLMN identification is a numerical value. The USIM card also stores a bit map that maps the PLMN identification to the actual RAT. Under certain circumstances (such as the present standards used by the China Mobile Communications Corporation (CMCC)), the field (referred to as the access technology field) in the USIM card that indicates the RAT associated with the PLMN does not differentiate between TD-SCDMA and WCDMA. In either case, a common setting referred to as “UTRAN” is used. As described below, this overlap may result in several undesired performance issues, including difficulty identifying which RAT a UE should connect to (either TD-SCDMA or WCDMA) when the ambiguous bit in question is set.

In particular, the position of each RAT in the RAT Priority List, may result in performance issues. If the most-recently acquired RAT does not match the first RAT in the RAT Priority List, when the UE attempts to reacquire the most recent RAT after a period of inactivity, the ambiguous access technology field may result in the UE attempting to access the incorrect RAT. For example, the ambiguous access technology field may result in a UE attempting to acquire service with TD-SCDMA when WCDMA is actually desired, or vice-versa. These undesired connection attempts result in extra connection attempts that will fail. These undesired connection attempts result in a UE performance loss.

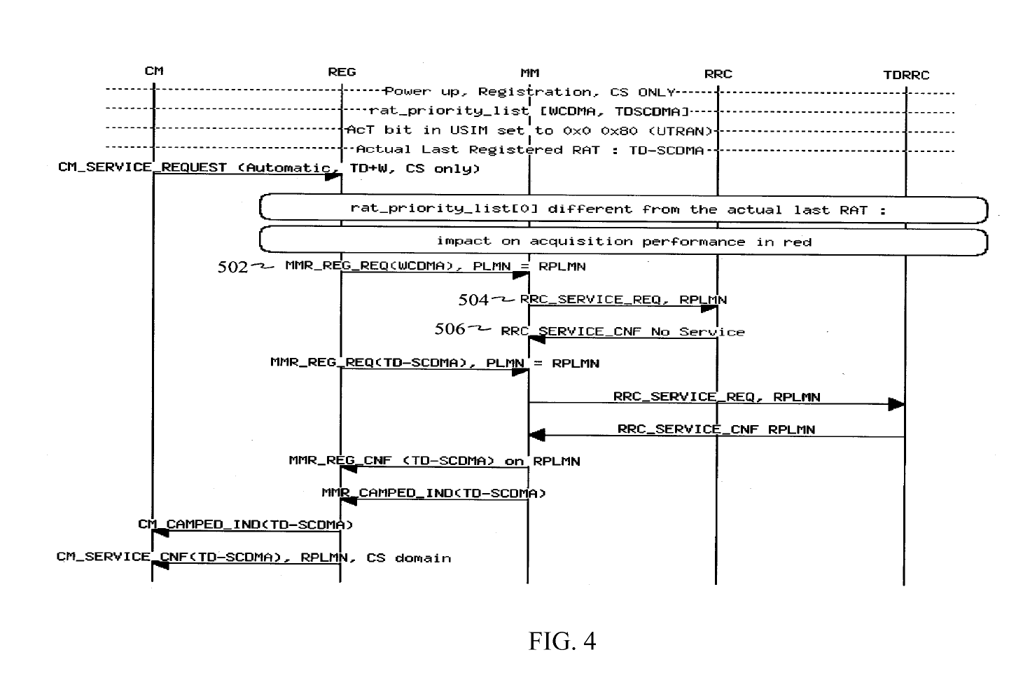

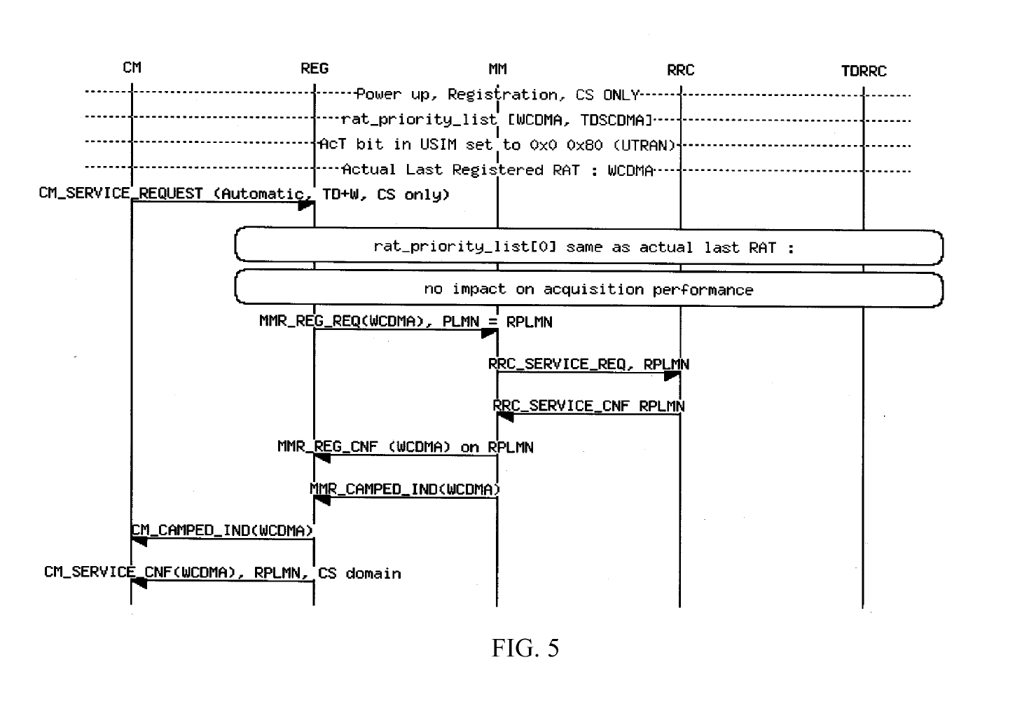

FIG. 4 is a call-flow diagram illustrating connection attempts by a UE. Message 502 (from a registration module (REG) to a mobility manager (MM)), and messages 504 and 506 (from the mobility manager to a radio resource controller (RRC)) may be sent if the UE attempts connection setup with an incorrect RAT as a result of the ambiguous access technology field. If, however, the most-recently acquired RAT does match the first RAT in the RAT Priority List, the undesired connection attempts will be avoided (as shown in the call-flow diagram of FIG. 5), albeit by chance rather than design.

Table 1 below illustrates the scenarios when the ambiguous access technology field may affect acquisition performance when the access technology field bits are set to the ambiguous value. In Table 1 “T” indicates TD-SCDMA and “W” indicates WCDMA.

TABLE 1

| Acquisition | Actual Last | Actual | Acquisition |
|---|---|---|---|
| Order in the RAT | Registered | Order of | Performance |
| Priority List | RAT | Acquisition | Affected? |
| W, T | T | W, T | Yes |
| T, W | T | T, W | No |
| T, W | W | T, W | Yes |
| W, T | W | W, T | No |

As illustrated in Table 1, when the actual order of acquisition calls for a RAT other than the last registered RAT to be selected, UE performance may be affected.

Offered is a solution to the ambiguous access technology field described above. A dedicated memory location, referred to as NV_RPLMNAcT (non-volatile registered PLMN access technology field), in the random-access memory of the UE is set aside to indicate whether the RAT selected should be TD-SCDMA or WCDMA in case the access technology field is set to the ambiguous value. The data in the new dedicated memory location may be associated with a PLMN. This new memory indicator will guide the UE with RAT selection to avoid the ambiguity described above and will improve performance by removing the ambiguity and the potential RAT uncertainty described above. NV_RPLMNAcT may be a single bit or a data field of multiple bits. In one aspect, if the dedicated memory location NV_RPLMNAcT is set in a particular manner, TD-SCDMA is indicated to be the last RAT acquired by the UE; if the dedicated memory location is not set, WCDMA is indicated to be the last RAT acquired by the UE. In another aspect, the UE's RAT history (including information known about RAT coverage area, etc.) may be stored and analyzed to determine which preferred RAT should be indicated in the new dedicated memory location. In another aspect, a user may indicate which RAT may be preferred based on the user's preference.

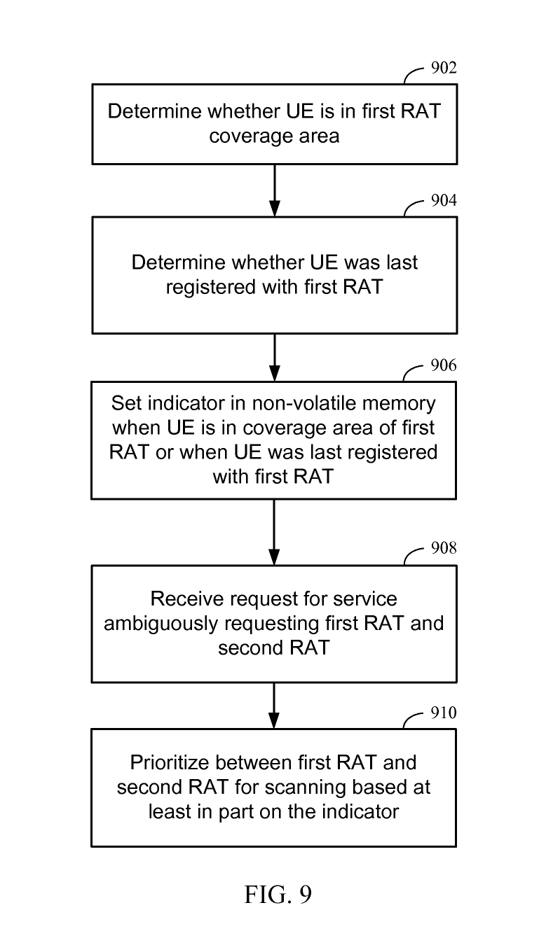

In another aspect, one of the unused bits in the dedicated memory location NV_RPLMNAcT, for example, bit 0 in Byte 5n−1 (which is also referred to as bit 8 of NV_RPLMNAcT), shall be defined as a bit associated with the TD-SCDMA radio access technology. (Byte 5n−1 is further described in FIG. 9 below.) This bit may be referred to as TDSCDMA_ACT_BIT. When set, this bit indicates that TD-SCDMA coverage has been detected. The TDSCDMA_ACT_BIT may be set when the UE is connected to TD-SCDMA or when coverage of a TD-SCDMA RAT is detected by the UE but the UE is connected to another RAT network such as GSM or Long Term Evolution (LTE). The TDSCDMA_ACT_BIT may be reset when the UE is connected to WCDMA or when coverage of a WCDMA RAT is detected by the UE but the UE is connected to another RAT network.

When both WCDMA and TD-SCDMA RATs are present in the Service Request, the TDSCDMA_ACT_BIT may be used to reorder the acquisition priority between WCDMA and TD-SCDMA. If TDSCDMA_ACT_BIT is set, TD-SCDMA may be given a higher priority. If TDSCDMAACT_BIT is not set WCDMA may be given a higher priority. To further improve performance, if coverage of one of WCDMA or TD-SCDMA is detected by a UE, during registration the other may be removed from the non-access stratum (NAS) layer list of RATs to be queried for service. For example, if coverage of WCDMA is detected, TD-SCDMA may be removed from the list of available PLMNs; similarly, if coverage of TD-SCDMA is detected, WCDMA shall be removed from the list of available PLMNs. This operation reflects a tendency for TD-SCDMA and WCDMA networks to operate in mutually exclusive geographical areas.

UE connection setup and RAT registration to avoid the RAT ambiguity is further described below.

During the registration, if the registered RAT is TD-SCDMA, the registration updates the non-volatile memory and USIM accordingly. While the USIM should follow the 3GPP specifications, the new non-volatile memory NV_RPLMNAcT may be set to distinguish between TD-SCDMA and WCDMA as described above.

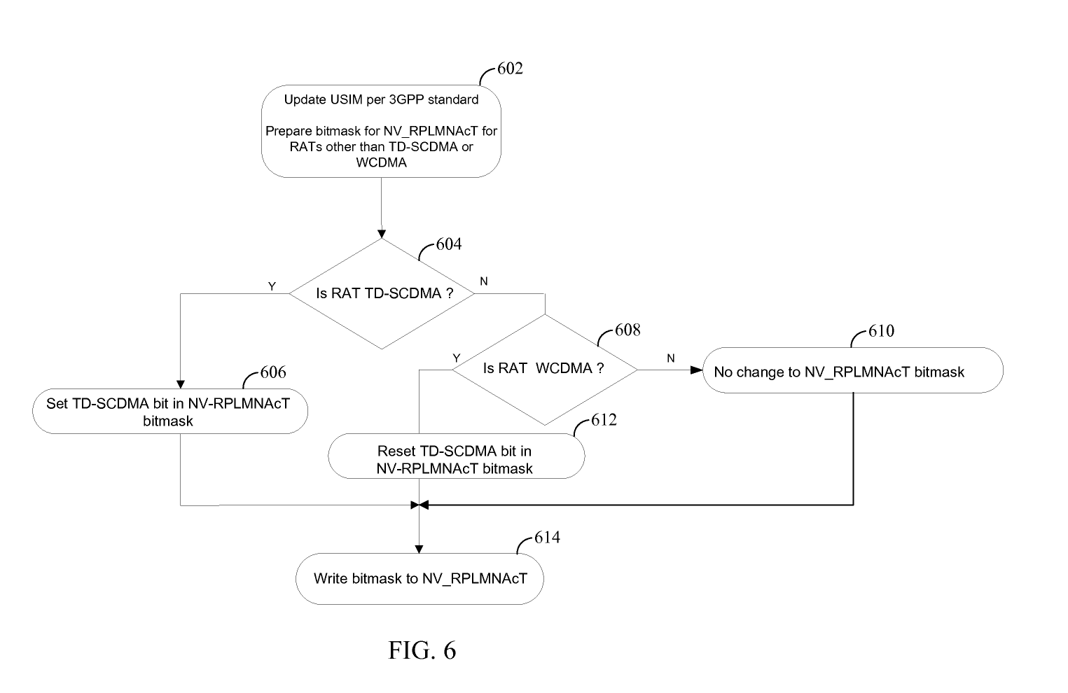

FIG. 6 shows a function performed by the UE when a new 3GPP RAT is acquired. As shown in block 602, the USIM RAT indicators are updated pursuant to the 3GPP standard. A bitmask is also prepared to be written to the NV_RPLMNAcT memory location, where the value of the bitmask for WCDMA or TD-SCDMA is determined as described below. The UE then determines if the acquired RAT is TD-SCDMA, as shown in block 604. If the acquired RAT is TD-SCDMA then the TDSCDMA_ACT_BIT in the NV_RPLMNAcT bitmask is set, the updated bitmask is written to NV_RPLMNAcT, as shown in block 614. If the UE determines the RAT is not TD-SCDMA, as shown in block 604, then the UE checks if the acquired RAT is WCDMA, as shown in block 608. If the RAT is not WCDMA, then the unchanged bitmask is written to NV_RPLMNAcT, as shown in block 610. If the RAT is WCDMA (608:YES), then the TD-SCDMA bit in NV_RPLMNAcT is reset, as shown in block 612, and the updated bitmask is written to NV_RPLMNAcT, as shown in block 614.

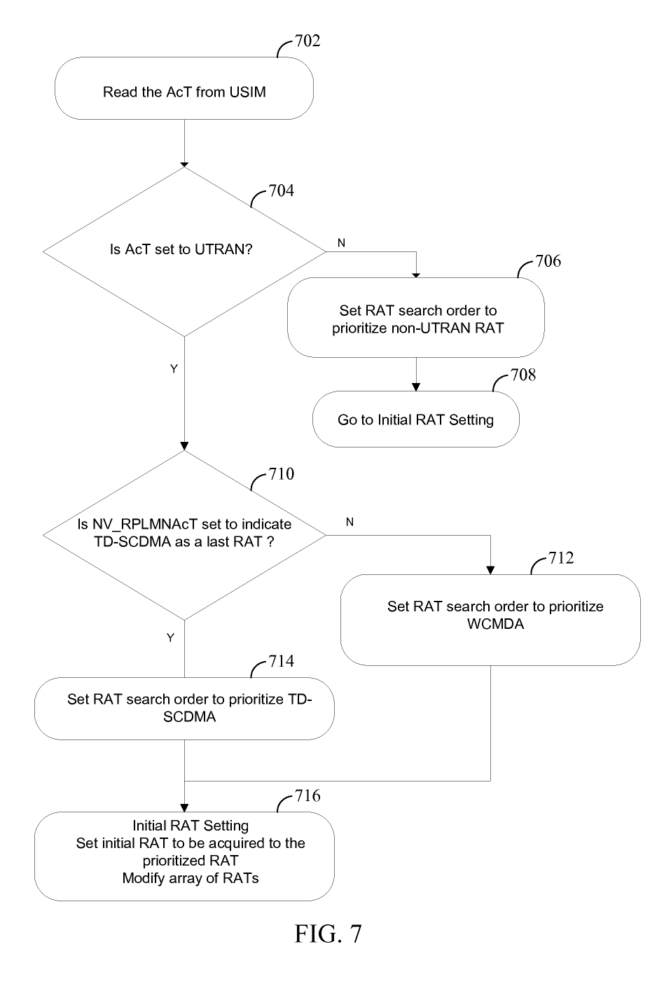

Setting of the TDSCDMA_ACT_BIT may be used to determine the relative priority between TD-SCDMA and WCDMA. If the bit is set, TD-SCDMA may be given priority over WCDMA. If the bit is not set, then WCDMA may be given priority over TD-SCDMA. This priority may be determined during RAT registration. During registration, the UE may determine the initial RAT to be used during the first Service Request sent to the Access Stratum. This determination may be based at least in part on the RPLMN RAT search order, as illustrated in FIG. 7. First, the access technology (AcT) is read from the USIM as shown in block 702. Next, the UE checks to see if the access technology is set to UTRAN, as shown in block 704. If the access technology is not set to UTRAN, the RAT search order is set accordingly to prioritize another RAT (such as GSM, LTE, etc.), as shown in block 706, and the UE goes to the initial RAT setting, as shown in block 708. If the access technology is set to UTRAN (704:YES), then the UE checks to see if NV_RPLMNAcT is set to indicate TD-SCDMA as the last accessed RAT, as shown in block 710. If the non-volatile memory does not indicate TD-SCDMA as the last accessed RAT, the RAT search order is set to prioritize WCDMA, as shown in block 712. If the non-volatile memory does indicate TD-SCDMA as the last accessed RAT (710:YES), the RAT search order is set to prioritize TD-SCDMA, as shown in block 714. Following block 712 or 714, the initial RAT is set to the prioritized RAT and the array of RAT priority is revised accordingly, as shown in block 716.

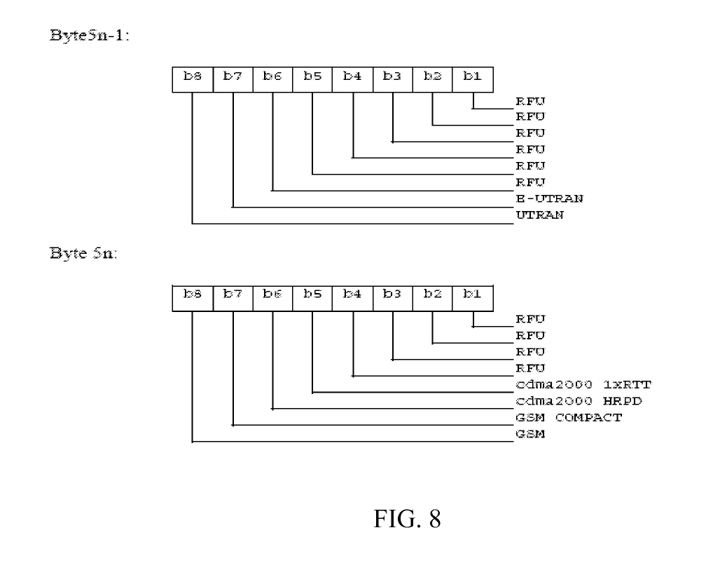

FIG. 8 illustrates exemplary bit fields of two bytes of the registered PLMN (RPLMN) access technology (AcT) field in the USIM defined in the 3GPP standard “Characteristics of the Universal Subscriber Module (USIM) application (3GPP TS 31.102, version 3.2.0 Release 9). The illustrated bytes (Byte 5n and Byte 5n−1) show bits corresponding to the recent RAT activity of the UE. The non-volatile memory NV_RPLMNAcT may duplicate the data available in the RPLMN AcT field, with the separate bit TDSCDMA_ACT_BIT set or not set based on TD-SCDMA or WCDMA coverage.

Table 2 illustrates an example of setting various memory fields. Specifically, Table 2 below, illustrates the contents of the PLMN lists of the USIM and of the non-volatile memory based on certain RAT coverage configurations. The RPLMN AcT field of the USIM in Table 2 shows different values for Byte 5n and Byte 5n−1 of FIG. 9, which indicate the most recently registered RAT. The NV_RPLMNAcT field of the non-volatile memory shown in Table 2 indicates the most recently registered RAT and the status of TD-SCDMA/WCDMA coverage through the TDSCDMA_ACT_BIT, which is the fourth number of the NV_RPLMNAcT field. When the TDSCDMA_ACT_BIT is set to 1, TD-SCDMA coverage is indicated; when the TDSCDMA_ACT_BIT is set to 0, WCDMA coverage is indicated. Table 2 also shows the RAT coverage status for various RATs, with a (R) indicating the last registered RAT.

TABLE 2

| RPLMN | | | | | |
|---|---|---|---|---|---|
| AcT | NV_RPLMNAcT | Coverage | | | |
| (USIM) | (NV) | TD-SCDMA | WCDMA | GSM | LTE |
| 0x80 00 | 0x80 00 | N | Y(R) | N | N |
| 0x80 00 | 0x81 00 | Y(R) | N | N | N |
| 0x00 80 | 0x01 80 | Y | N | Y(R) | N |
| 0x40 00 | 0x41 00 | Y | N | N | Y(R) |
| 0x00 80 | 0x00 80 | N | N | Y(R) | N |
| 0x40 00 | 0x40 00 | N | N | N | Y(R) |

When RPLMN AcT is set to 0x80 00, it indicates the ambiguous “UTRAN” value which can be TD-SCDMA or WCDMA. When NV_RPLMNAcT is 0x80 00, it indicates that WCDMA coverage is available, hence the “0” value in the fourth digit, indicating the TDSCDMA_ACT_BIT is not set. When NV_RPLMNAcT is 0x81 00, as it is in the second row of Table 2, TD-SCDMA coverage is available, hence the “1” value in the fourth digit, indicating the TDSCDMA_ACT_BIT is set. When RPLMN AcT is set to 0x00 80, as it is in the third column of Table 2, the most recent registered RAT is GSM. In this third row, NV_RPLMNAcT is 0x01 80, indicating that GSM was the most recently registered RAT, but that TD-SCDMA coverage is available. In the fourth row, RPLMN AcT is set to 0x40 00, which indicates LTE is the most recently registered RAT. NV_RPLMNAcT is 0x41 00, indicating LTE as the most recently registered RAT but also indicating that TD-SCDMA coverage is available. In the fifth row, RPLMN AcT is set to 0x00 80 indicating recent GSM coverage, while NV_RPLMNAcT is set to 0x00 80 indicating both the recent GSM coverage and available WCDMA coverage. Finally, in the row column, RPLMN AcT is set to 0x40 00 indicating LTE as the most recently registered RAT and NV_RPLMNAcT is set to 0x40 00 indicating both LTE as the most recently registered RAT and available WCDMA coverage.

As shown in FIG. 9 a UE may determine whether a user equipment (UE) is in a coverage area of a first radio access technology (RAT), as shown in block 902. A UE may determine whether the UE was last registered with the first RAT, as shown in block 904. The UE may set an indicator in non-volatile memory of the UE, when either the UE is determined to be in the coverage area of the first RAT or the UE was last registered with the first RAT, as shown in block 906. In block 908, a request for service ambiguously requesting the first RAT and a second RAT may be received. The UE may prioritize between the first RAT and the second RAT for scanning based at least in part on the indicator, as shown in block 910.

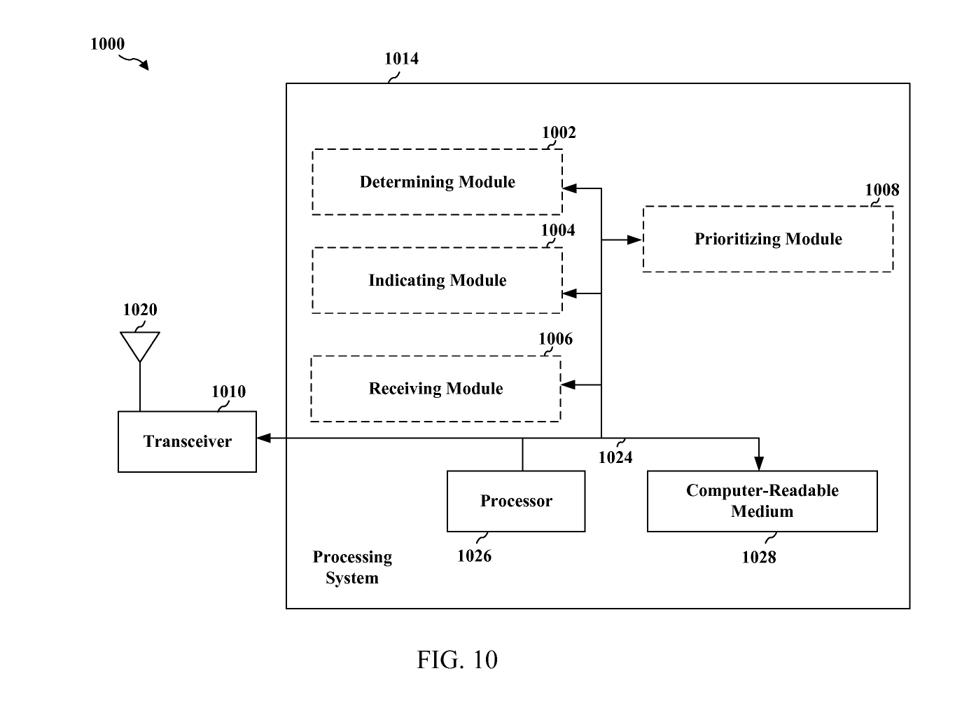

FIG. 10 is a diagram illustrating an example of a hardware implementation for an apparatus 1000 employing a RAT identification system 1014. The RAT identification system 1014 may be implemented with a bus architecture, represented generally by a bus 1024. The bus 1024 may include any number of interconnecting buses and bridges depending on the specific application of the RAT identification system 1014 and the overall design constraints. The bus 1024 links together various circuits including one or more processors and/or hardware modules, represented by a processor 1026, a determining module 1002, an indicating module 1004, a receiving module 1006, a prioritizing module 1008 and a computer-readable medium 1028. The bus 1024 may also link various other circuits such as timing sources, peripherals, voltage regulators, and power management circuits, which are well known in the art, and therefore, will not be described any further.

The apparatus includes the RAT identification system 1014 coupled to a transceiver 1022. The transceiver 1022 is coupled to one or more antennas 1020. The transceiver 1022 provides a means for communicating with various other apparatus over a transmission medium. The RAT identification system 1014 includes the processor 1026 coupled to the computer-readable medium 1028. The processor 1026 is responsible for general processing, including the execution of software stored on the computer-readable medium 1028. The software, when executed by the processor 1026, causes the RAT identification system 1014 to perform the various functions described supra for any particular apparatus. The computer-readable medium 1028 may also be used for storing data that is manipulated by the processor 1026 when executing software. The RAT identification system 1014 further includes the determining module 1002 for determining whether a UE is in a coverage area of a first RAT and for determining whether the UE was last registered with the first RAT. The RAT identification system 1014 further includes the indicating module 1004 for setting an indicator in non-volatile memory of the UE, when either the UE is determined to be in the coverage area of the first RAT or the UE was last registered with the first RAT. The RAT identification system 1014 further includes the receiving module 1006 for receiving a request for service ambiguously requesting the first RAT and a second RAT. The RAT identification system 1014 further includes the prioritizing module 1008 for prioritizing between the first RAT and the second RAT for scanning based at least in part on the indicator. The determining module 1002, the indicating module 1004, the receiving module 1006, the prioritizing module 1008 may be software modules running in the processor 1026, resident/stored in the computer readable medium 1028, one or more hardware modules coupled to the processor 1026, or some combination thereof. The RAT identification system 1014 may be a component of the UE 250 and may include the memory 272 and/or the processor 270.

In one configuration, the apparatus 1000 for wireless communication includes means for determining. The determining means may be the determining module 1002 and/or the RAT identification system 1014 of the apparatus 1000 configured to perform the functions recited by the determining means. The means for determining may include the RAT identification module 391, the antenna 352, the receiver 354, the controller/processor 390, and/or the memory 392. In another aspect, the aforementioned means may be any module or any apparatus configured to perform the functions recited by the aforementioned means.

In one configuration, the apparatus 1000 for wireless communication includes means for indicating. The indicating means may be the indicating module 1004 and/or the RAT identification system 1014 of the apparatus 1000 configured to perform the functions recited by the indicating means. The means for indicating may include the RAT identification module 391, the controller/processor 390, and/or the memory 392. In another aspect, the aforementioned means may be any module or any apparatus configured to perform the functions recited by the aforementioned means.

In one configuration, the apparatus 1000 for wireless communication includes means for receiving. The receiving means may be the receiving module 1006 and/or the RAT identification system 1014 of the apparatus 1000 configured to perform the functions recited by the receiving means. The means for receiving may include the RAT identification module 391, the antenna 352, the receiver 354, the controller/processor 390, the transceiver 1010, and/or the memory 392. In another aspect, the aforementioned means may be any module or any apparatus configured to perform the functions recited by the aforementioned means.

In one configuration, the apparatus 1000 for wireless communication includes means for prioritizing. The prioritizing means may be the prioritizing module 1008 and/or the RAT identification system 1014 of the apparatus 1000 configured to perform the functions recited by the prioritizing means. The means for prioritizing may include the RAT identification module 391, the controller/processor 390, and/or the memory 392. In another aspect, the aforementioned means may be any module or any apparatus configured to perform the functions recited by the aforementioned means.

Several aspects of a telecommunications system has been presented with reference to TD-SCDMA and WCDMA systems. As those skilled in the art will readily appreciate, various aspects described throughout this disclosure may be extended to other telecommunication systems, network architectures and communication standards. Specifically, a UE may store an indication of RAT coverage in non-volatile memory for RATs other than TD-SCDMA or WCDMA. For example, a UE may store an indicator of TDD/FDD LTE, or other RAT coverage. Similarly, the UE may store an indicator of a last registered RAT, such as TDD/FDD LTE or other previously registered RAT. Such indicators may be helpful in the context of TDD/FDD LTE as TDD/FDD LTE also share an access technology bit, shown in FIG. 8 as b7 (E-UTRAN) of Byte 5n−1. By way of example, various aspects may also be extended to other systems such as High Speed Downlink Packet Access (HSDPA), High Speed Uplink Packet Access (HSUPA), High Speed Packet Access Plus (HSPA+) and TD-CDMA. Various aspects may also be extended to systems employing CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
determining whether a user equipment (UE) is in a coverage area of a first radio access technology (RAT);
determining whether the UE was last registered with the first RAT;
setting an indicator in non-volatile memory of the UE, when either the UE is determined to be in the coverage area of the first RAT or the UE was last registered with the first RAT;
receiving a request for service ambiguously requesting the first RAT and a second RAT; and
prioritizing between the first RAT and the second RAT for scanning based at least in part on the indicator.

2. The method of claim 1, in which the first RAT is Time Division-Synchronous Code Division Multiple Access (TD-SCDMA) and the second RAT is Wideband-Code Division Multiple Access (W-CDMA).

3. The method of claim 1, in which the first RAT is time division duplex (TDD) Long Term Evolution (LTE) and the second RAT is frequency division duplex (FDD) LTE.

4. The method of claim 1, in which the indicator is set when the UE is registered on a second RAT and the UE is determined to be in the coverage area of the first RAT.

5. The method of claim 1, further comprising removing a second RAT from a list of RATs when the UE is determined to be in the coverage area of the first RAT.

6. An apparatus configured for wireless communication comprising:
means for determining whether a user equipment (UE) is in a coverage area of a first radio access technology (RAT);
means for determining whether the UE was last registered with the first RAT;
means for setting an indicator in non-volatile memory of the UE, when either the UE is determined to be in the coverage area of the first RAT or the UE was last registered with the first RAT;
means for receiving a request for service ambiguously requesting the first RAT and a second RAT; and
means for prioritizing between the first RAT and the second RAT for scanning based at least in part on the indicator.

7. The apparatus of claim 6, in which the first RAT is Time Division-Synchronous Code Division Multiple Access (TD-SCDMA) and the second RAT is Wideband-Code Division Multiple Access (W-CDMA).

8. The apparatus of claim 6, in which the first RAT is time division duplex (TDD) Long Term Evolution (LTE) and the second RAT is frequency division duplex (FDD) LTE.

9. The apparatus of claim 6, in which the indicator is set when the UE is registered on a second RAT and the UE is determined to be in the coverage area of the first RAT.

10. The apparatus of claim 6, further comprising means for removing a second RAT from a list of RATs when the UE is determined to be in the coverage area of the first RAT.

11. A computer program product for wireless communication in a wireless network, comprising:
a non-transitory computer-readable medium having non-transitory program code recorded thereon, the non-transitory program code comprising:
program code to determine whether a user equipment (UE) is in a coverage area of a first radio access technology (RAT);
program code to determine whether the UE was last registered with the first RAT;
program code to set an indicator in non-volatile memory of the UE, when either the UE is determined to be in the coverage area of the first RAT or the UE was last registered with the first RAT;
program code to receive a request for service ambiguously requesting the first RAT and a second RAT; and
program code to prioritize between the first RAT and the second RAT for scanning based at least in part on the indicator.

12. The computer program product of claim 11, in which the first RAT is Time Division-Synchronous Code Division Multiple Access (TD-SCDMA) and the second RAT is Wideband-Code Division Multiple Access (W-CDMA).

13. The computer program product of claim 11, in which the first RAT is time division duplex (TDD) Long Term Evolution (LTE) and the second RAT is frequency division duplex (FDD) LTE.

14. The computer program product of claim 11, in which the indicator is set when the UE is registered on a second RAT and the UE is determined to be in the coverage area of the first RAT.

15. The computer program product of claim 11, in which the program code further comprises program code to remove a second RAT from a list of RATs when the UE is determined to be in the coverage area of the first RAT.

16. An apparatus for wireless communication, comprising:
a memory; and
at least one processor coupled to the memory, the at least one processor being configured:
to determine whether a user equipment (UE) is in a coverage area of a first radio access technology (RAT);
to determine whether the UE was last registered with the first RAT;
to set an indicator in non-volatile memory of the UE, when either the UE is determined to be in the coverage area of the first RAT or the UE was last registered with the first RAT;
to receive a request for service ambiguously requesting the first RAT and a second RAT; and
to prioritize between the first RAT and the second RAT for scanning based at least in part on the indicator.

17. The apparatus of claim 16, in which the first RAT is Time Division-Synchronous Code Division Multiple Access (TD-SCDMA) and the second RAT is Wideband-Code Division Multiple Access (W-CDMA).

18. The apparatus of claim 16, in which the first RAT is time division duplex (TDD) Long Term Evolution (LTE) and the second RAT is frequency division duplex (FDD) LTE.

19. The apparatus of claim 16, in which the indicator is set when the UE is registered on a second RAT and the UE is determined to be in the coverage area of the first RAT.

20. The apparatus of claim 16, in which the at least one processor is further configured to remove a second RAT from a list of RATs when the UE is determined to be in the coverage area of the first RAT.
